(19) United States
(12) Patent Application Publication
(10) Pub. No.: US 2014/0197691 A1
(43) Pub. Date: Jul. 17, 2014

(54) Wireless Energy Transfer for Misaligned Resonators

(71) Applicant: MITSUBISHI ELECTRIC RESEARCH LABORATORIES, INC, Cambridge, MA (US)

(72) Inventors: Bingnan Wang, Quincy, MA (US); Jing Wu, Granada Hills, CA (US); William Yerazunis, Acton, MA (US); Koon Hoo Teo, Lexington, MA (US)

(73) Assignee: MITSUBISHI ELECTRIC RESEARCH LABORATORIES, INC, Cambridge, MA (US)

(21) Appl. No.: 13/740,323

(22) Filed: Jan. 14, 2013

(51) Int. Cl. H01F 38/14

(52) U.S. Cl. CPC H01F 38/14
USPC 307/104

(57) ABSTRACT

A system for transferring energy wirelessly includes a source for generating a circular polarized field in response to receiving the energy and a sink strongly coupled to the source for receiving the energy wirelessly via a resonant coupling of the field.

### FIELD OF THE INVENTION

The present invention relates generally to transferring energy, and more particularly, to improving wireless energy transfer between misaligned resonators.

### BACKGROUND OF THE INVENTION

Various methods have being developed to use wireless power transmission between a transmitter and a receiver coupled to a device. Such methods generally fall into two categories. One method is based on a far-field radiation propagated between a transmit antenna and a receive antenna. The receive antenna collects the power and rectifies the power for use. That method is inefficient because power decreases as the inverse square distance between the antennas, so power transfer for reasonable distances, e.g., 1 to 2 meters, is inefficient. Additionally, since the transmitting system radiates plane waves, unintentional radiation can interfere with other electrical systems if not properly controlled by filtering.

Other methods for wireless energy transmission techniques are based on inductive coupling between a transmit antenna embedded in, for example, a “charging” mat or a surface and a receive antenna of a device. That method has the disadvantage that the spacing between transmit and receive antennas must be relatively small e.g., within a small number of millimeters.

Methods for transferring energy wirelessly using resonant coupling have been developed. In resonant coupling, two resonators, i.e., two resonant electromagnetic objects, such as a source and a sink, interact with each other under resonance conditions. The resonant coupling transfers energy from the source to the sink over a mid-range distance, e.g., a fraction of the resonant frequency wavelength. Examples of the resonant coupling system are disclosed in U.S. Patent Publication 20080278264 and 20070222542.

Efficiency is of importance in a wireless energy transfer system due to the losses occurring during the wireless transmission of the energy. Since wireless energy transmission is often less efficient than wired transfer, efficiency is of an even greater concern for wireless energy transfer applications. As a result, there is a need for methods and systems that provide wireless energy to various devices efficiently.

To improve the efficiency of the energy transfer, a wireless transfer system may require two resonators exchanging the energy to be aligned within a certain degree. Adequate alignment may require proper positioning of and/or tuning of the resonators. Such alignment can he expensive and time consuming, especially for mobile applications. For example, sonic methods address misalignment issue by using multiple differently oriented antennas, see e.g., U.S. Publication 20110254503. Multiple antennas can be suboptimal for many applications.

Thus, there is a need for devices, systems, and methods for improving the efficiency of the energy transfer system using resonant coupling without fine alignment of resonators of the wireless charging system.

### SUMMARY OF THE INVENTION

Embodiments of the invention are based on the realization that coupling degradation due to misalignment can be reduced by generating circularly polarized magnetic field for coupling a source to a sink.

One embodiment of the invention discloses a system configured to exchange energy wirelessly. The system includes a structure configured to exchange the energy wirelessly via a coupling of evanescent waves, wherein the structure is electromagnetic (EM), circularly polarized and non-radiative, and wherein the structure generates an EM near-field in response to receiving the energy.

Another embodiment discloses a system for transferring energy wirelessly. The system includes a source for generating a circular polarized, field in response to receiving the energy and a sink strongly coupled to the source for receiving the energy wirelessly via a resonant coupling of the field.

Another embodiment discloses a method for transferring energy wirelessly. The steps of the method include generating a circular polarized field in response to receiving the energy and transferring the energy wirelessly via a resonant coupling of the field.

Another embodiment discloses a method of generating circularly polarized magnetic field by a transmitting module including a single-feed resonator or multiple coils fed with a phase difference. The receiving module can include a single linearly polarized resonator, or orthogonal resonator sets.

Yet another embodiment discloses a method of enhancing the coupling of the above embodiment by arranging a metal plate near the resonator, which provides partial confinement to the magnetic field and prevents the magnetic field from the resonators from going in an opposite direction from the receiving resonator.

Yet another embodiment discloses a system with asymmetric resonators. The transmitting resonator can differ in size from the receiving resonator. In some embodiments, the receiving resonator tolerates up to three degrees of freedom in motion while maintaining efficient energy transfer.

### BRIEF DESCRIPTION OF THE DRAWINGS

FIG. 1 is a resonant coupling system for exchanging energy between a first resonator and a second resonator according to some embodiments of the invention;

FIG. 2 is a schematic of polarization of electromagnetic waves;

FIG. 3 is a schematic of elevation and azimuth rotations causing the misalignment issue;

FIG. 4 is a plot of power transfer efficiency degradation due to elevation rotation;

FIG. 5 is a schematic of polarization loss factor due to polarization difference between dipole antennas: vertical, horizontal and circular polarization;

FIG. 6 is a schematic of an exemplar system for reducing the degradation of the energy transfer due to elevation rotation of the resonator;

FIG. 7 is a plot of magnetic flux of the system of FIG. 6;

FIG. 8 is a schematic of a system for improving the energy transfer with azimuth rotation of the resonator;

FIG. 9 is a plot of magnetic flux of the system of FIG. 8;

FIG. 10 is a schematic of wireless energy transfer system according to some embodiments of the invention;

FIG. 11 is a plot of magnetic flux of the system of FIG. 10;

FIG. 12 is a schematic of system for generating circularly polarized magnetic field according to some embodiments of the invention;

FIG. 13 is a pattern of energy transfer efficiency in a polar coordinate system;

FIG. 14 is an illustration of the shielding enhancement used by some embodiments of the invention;

FIG. 15 is a schematic of the geometry of wireless power transfer system according to some embodiments of the invention;

FIGS. 16A-B are plots of the energy transfer efficiency for the system according to some embodiments of the invention;

FIG. 17 is a schematic of an asymmetric wireless energy transfer system according to one embodiment;

FIG. 18 is a schematic of the rotations of tie receiving resonator of the system of FIG. 17;

FIGS. 19A-B are plots of the energy transfer efficiency for the system according to some embodiments of the invention;

FIGS. 20A-B are plots of the energy transfer efficiency for the system according to some embodiments of the invention;

FIGS. 21A-B are plots of the energy transfer efficiency for the system according to some embodiments of the invention; and

FIG. 22 is a table showing wireless energy transfer efficiency under different rotation misalignments.

### DETAILED DESCRIPTION OF THE PREFERRED EMBODIMENTS

For wireless charging applications, an energy receiving device, i.e., a sink, may be mobile and not aligned well with an energy transmitting device, i.e., a source. It is desirable to improve such misalignment tolerance for more efficient energy transfer. Embodiments of the invention are based on a general realization that misalignment tolerance between the source and the sink can be improved with a circularly polarized magnetic field.

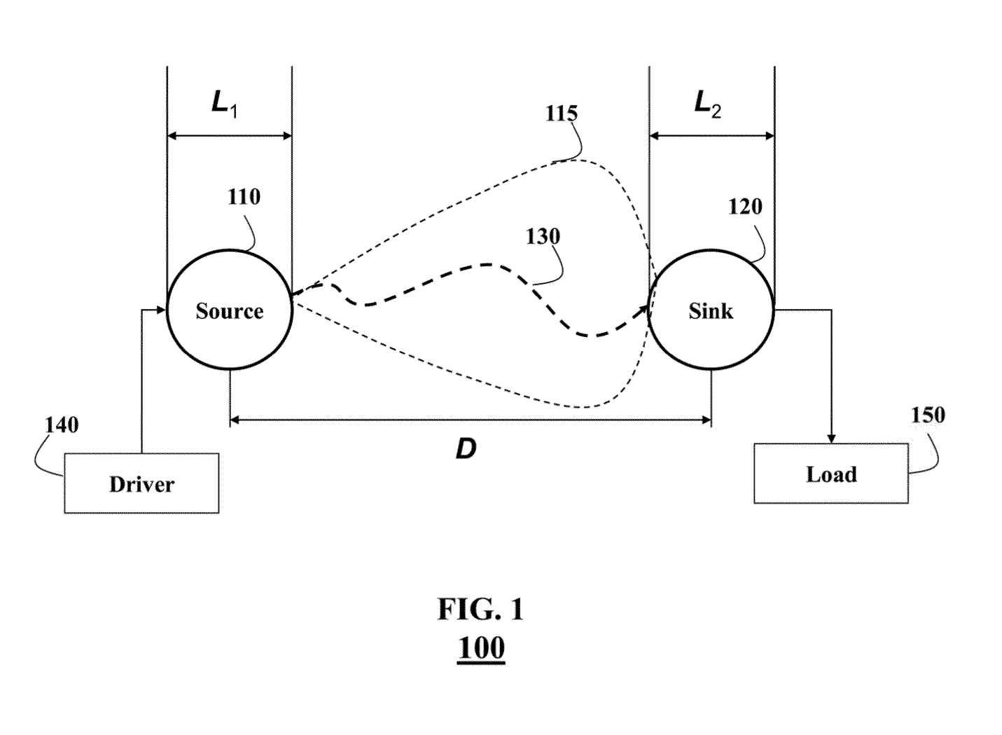

FIG. 1 shows a resonant coupling system 100 for exchanging energy between a first resonator, e.g., a source 110, and a second resonator, e.g., a sink 120, according to some embodiments of the invention. A driver 140 inputs the energy into the resonant source to form an oscillating electromagnetic field 115. In various embodiments of the invention, the field 115 is circularly polarized.

The excited electromagnetic field attenuates at a rate with respect to the excitation signal frequency at driver or self-resonant frequency of source and sink for a resonant system. However, if the resonant sink absorbs more energy than is lost during each cycle, then most of the energy is transferred to the sink. Operating the resonant source and the resonant sink at the same resonant frequency ensures that the resonant sink has low impedance at that frequency, and that the energy is optimally absorbed.

The energy is transferred, over a distance D, between resonant objects, e.g., the resonant source having a size L₁ and the resonant sink having a size L₂. The driver connects a power provider to the source, and the resonant sink is connected to a power consuming device, e.g., a resistive load 150. Energy is supplied by the driver to the resonant source, transferred wirelessly and non-radiatively from the resonant source to the resonant sink, and consumed by the load.

The wireless non-radiative energy transfer is performed using the field 115, e.g., the electromagnetic field or an acoustic field of the resonant system. For simplicity of this specification, the field 115 is an electromagnetic field. During the coupling of the resonant objects, evanescent waves 130 are propagated between the resonant source and the resonant sink.

In some embodiments of the invention, the source 110 generates a circularly polarized magnetic field upon receiving the energy, e.g., from the driver. In one embodiment, the source includes a pair of orthogonal coils and the driver controls phases in each coil to generate the circularly polarized magnetic field. In another embodiment, the source includes a metal sheet arranged adjacent to the coils the plate prevents the field to propagate in a direction opposite to a direction 130 of the energy transfer.

Polarization

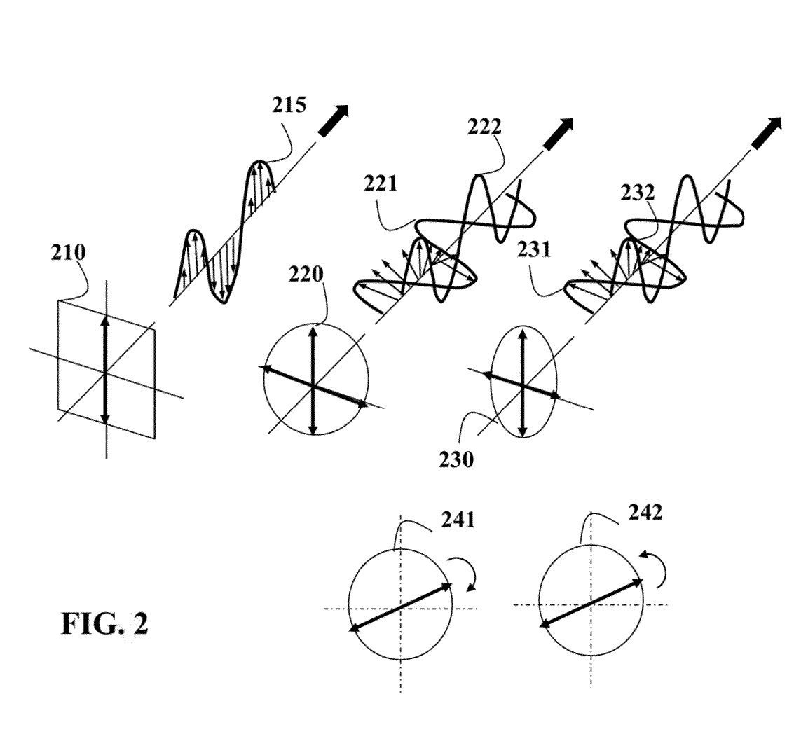

FIG. 2 shows examples of polarization of electromagnetic waves, such as linear 215, circular 221 and 222 and elliptical 231 and 232 polarizations. The polarization of an electromagnetic wave is defined as the orientation of oscillations in a plane perpendicular to a direction of travel of a transverse wave of the electric field or magnetic field vector. If the vector appears to rotate with time, then the wave is elliptically polarized 230. The ellipse may vary in ellipticity from a circle 220 to a straight line 210, or from circular to linear polarization. So, in a general sense, all polarizations may be considered to be elliptical.

As used herein, the electromagnetic held is circularly polarized if the field includes two perpendicular fields of substantially equal amplitude and a 90° difference in phase. The field is linearly polarized if the field consists of one field and a vector of the field does not rotate over time. There are two type of circular polarization, i.e., right handed circular polarization (RHCP, 242) and left handed circular polarization (LHCP, 241). The rotation follows counterclockwise and clockwise direction, respectively.

A circularly polarized magnetic field may be generated by a transmitting source including a single-feed resonator or multiple coils fed with phase difference. The sink can include a single linearly polarized resonator or orthogonal resonator sets. The rotations may take place around all three axis of a Cartesian coordinate system.

For example, for a wireless energy transfer system with two orthogonal coils as transmitting resonator of the source, adding a 90 degree phase difference to the input leads to a circularly polarized magnetic field. An identical orthogonal resonator, i.e., sink, arranged in the near field region, and coupled side-by-side with transmitting resonators of the source maintains similar energy transfer efficiency, regardless of its rotation. A single linearly polarized receiving resonator maintains uniform transfer efficiency pattern for rotations around at least two axes. Without the circular polarized magnetic field, a single resonator can only maintain uniform transfer efficiency around one axis.

Coupling Degradation Due to Misalignment

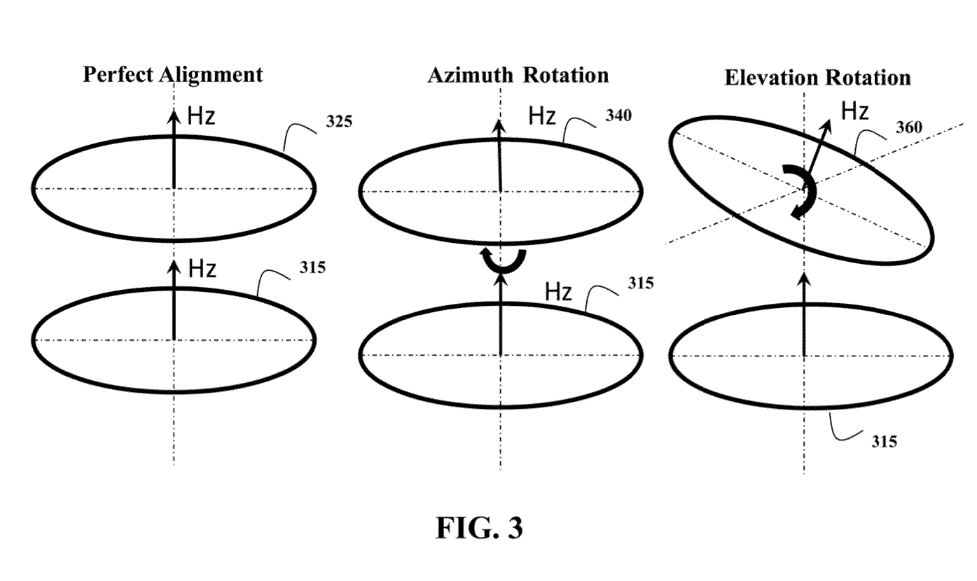

FIG. 3 shows an example of elevation and azimuth rotations causing the misalignment issue. A typical misalignment may involve rotations and displacements, simultaneously or respectively. For conventional coils, the coupling coefficient between source coils 315 and sink coils 325 is proportional to the magnetic flux generated by the source coil crossing the sink coil. For two linearly polarized magnetic coils, the vector spatial separation is perpendicular to the surface of the resonator. The rotations include azimuth rotation and elevation rotation, meaning rotation along axis and radian direction of the coils, respectively.

In azimuth rotation, the receive coil 340 rotates along the z axis. In elevation rotation, receive coil 360 rotates along the x or y axis. The misalignment loss due to elevation rotation can be approximated by Γ=cos²(θ), where θ is the angle between polarization vectors.

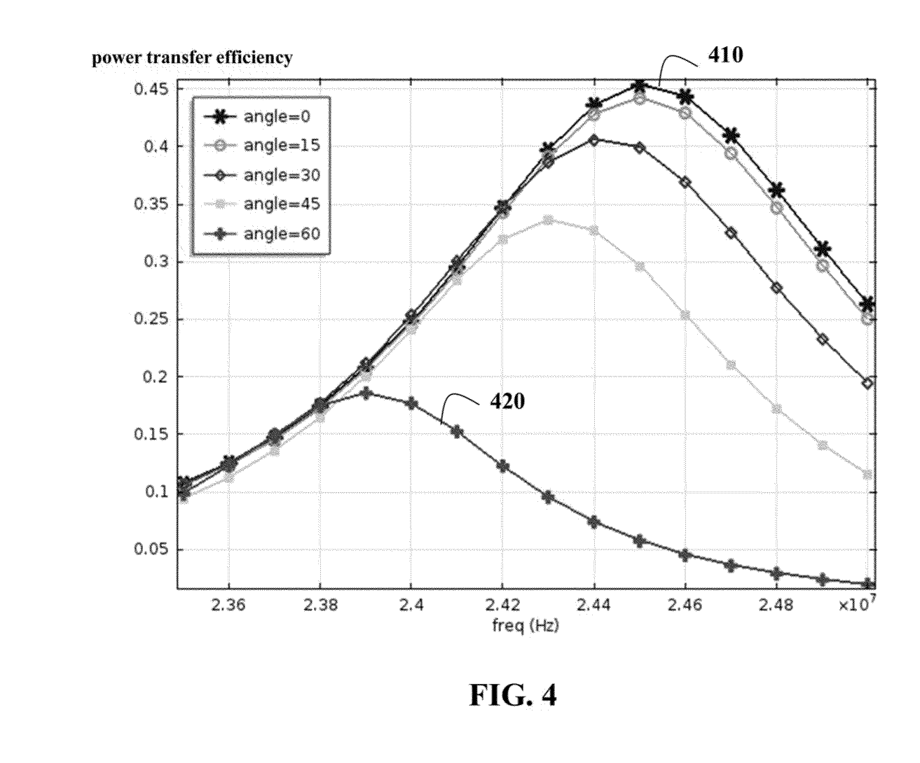

FIG. 4 shows a simulation result of power transfer efficiency degradation due to elevation rotation at 24 MHz. The efficiency 410 for the coil system has a maximum efficiency of 46%, while the efficiency decreases to 18% after an elevation rotation of 60 degrees.

Polarization Loss Factor (PLF)

In some embodiments, the circular polarized field satisfies the following conditions: (1) the field vector has two orthogonal components; (2) the two orthogonal components have substantially equal magnitude; and (3) the two orthogonal components have substantially 90 degree phase difference.

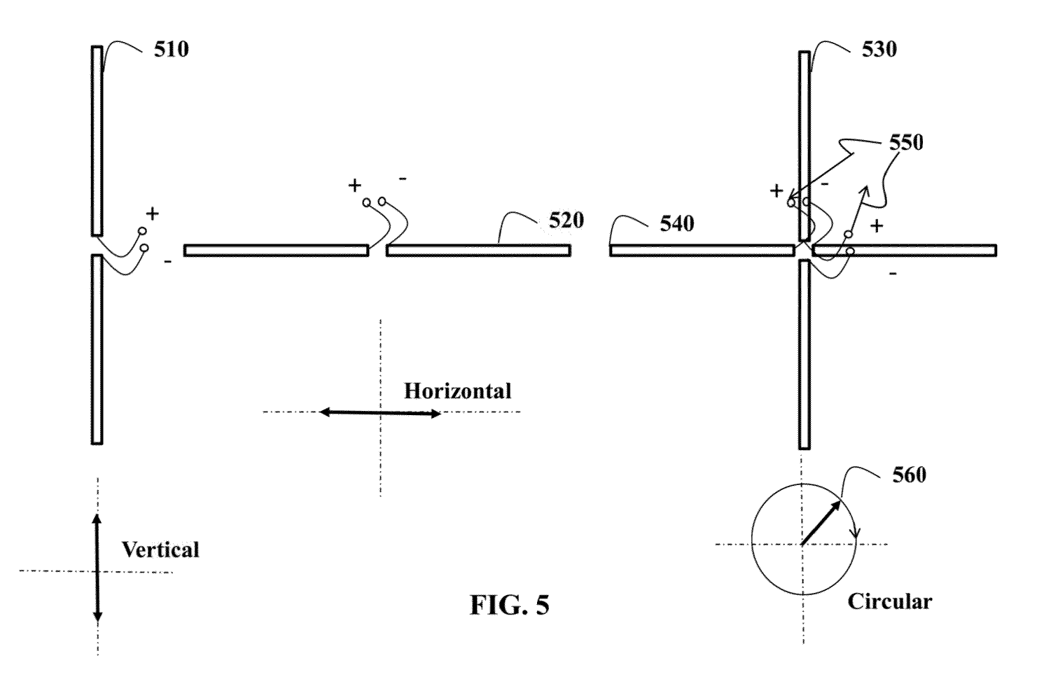

FIG. 5 is an example of polarization loss factor due to polarization difference between dipole antennas: vertical, horizontal and circular polarization. A dipole antenna 510 placed vertically has linear (vertical) polarization. A dipole antenna 520 placed horizontally has linear (horizontal) polarization. Two dipole antennas 530 and 540 placed orthogonally with 90 degree phase shifter 550 are circularly polarized. The polarization 560 can be RHCP or LHCP, depending on negative or positive phase delay. Circularly polarization can reduce the misalignment issue. Polarization loss factor (PLF) equals one circular polarization to circular polarization.

Coupling Via Side-By-Side Resonators

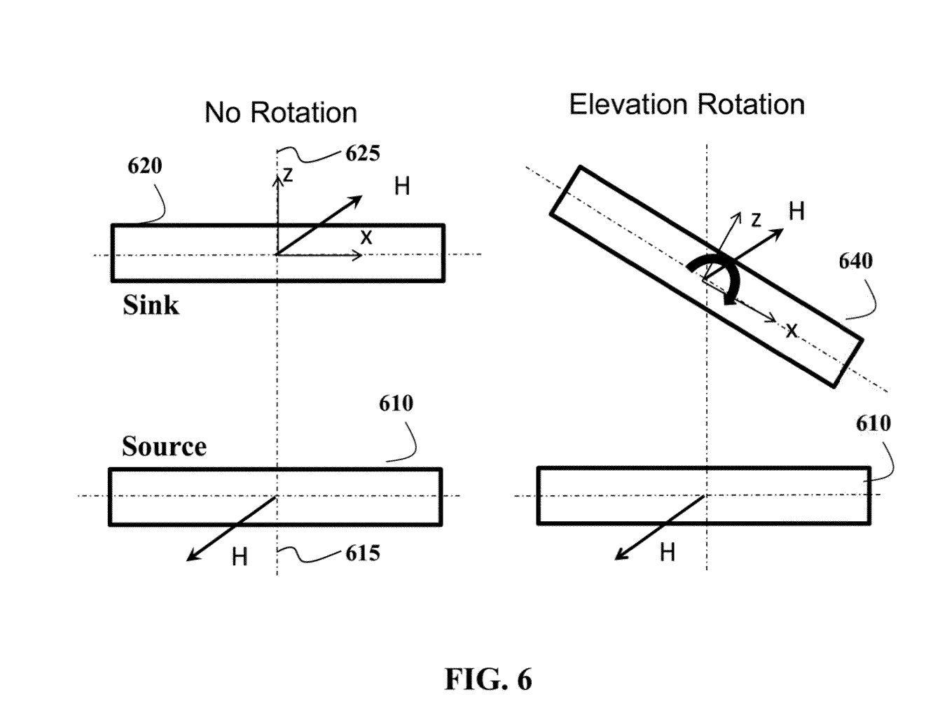

FIG. 6 shows a schematic of an exemplar system for reducing the degradation of the energy transfer due to elevation rotation of the resonator. Two rectangular coils 610 and 620 are aligned side-by-side, as used herein side-by-side means that a vector of a spatial separation is parallel to the surface of the resonator. For example, an axis 615 of the coil of the source 610 and an axis 625 of the coil of the sink 620 are in one plane. In this embodiment, the magnetic flux crossing the sink resonator is not reduced significantly during elevation rotation of 640. The decrease of magnetic flux due to the upper branch of the resonator is compensated by the increased magnetic flux due to the lower branch.

The coupling coefficient of the resonant system is proportional to the magnetic flux from the source crossing the sink. The magnetic field is inversely proportional to the distance

$$H ( z ) ∝ \frac{1}{{z}_{0} + z} ,$$

The magnetic flux ψ can be approximated by integration on the coil:

$$ψ = {\int }_{- L / 2 , - W / 2}^{L / 2 , W / 2} ( \frac{1}{{z}_{0} + z} ) d x d z ,$$

where L and W are length and width of the resonator, z₀ is the distance between the source and sink resonator, from center to center. After the elevation rotation by θ=0˜90 degree, the flux can be approximated as:

$$ψ ( θ ) = {\int }_{- L / 2 , - W / 2}^{L / 2 , W / 2} ( \frac{1}{{z}_{0} + x sin θ + z cos θ} ) d x d z$$

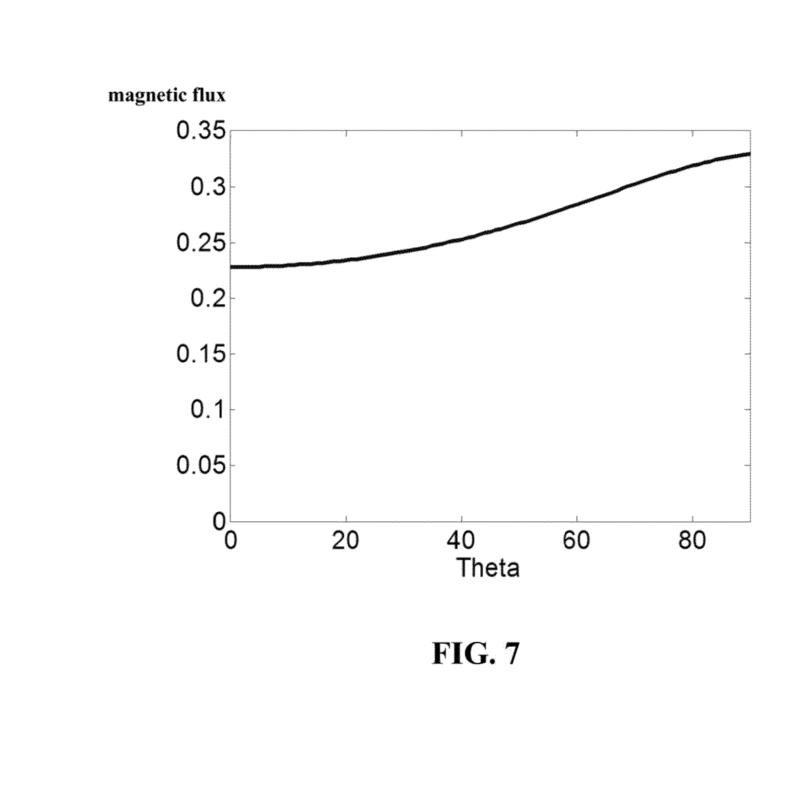

FIG. 7 shows a plot of magnetic flux of the system of FIG. 6 given an exemplar rectangular coil with L=0.8 m, W=0.15 m, z0=0.35 m. The magnetic flux is increased after the rotation.

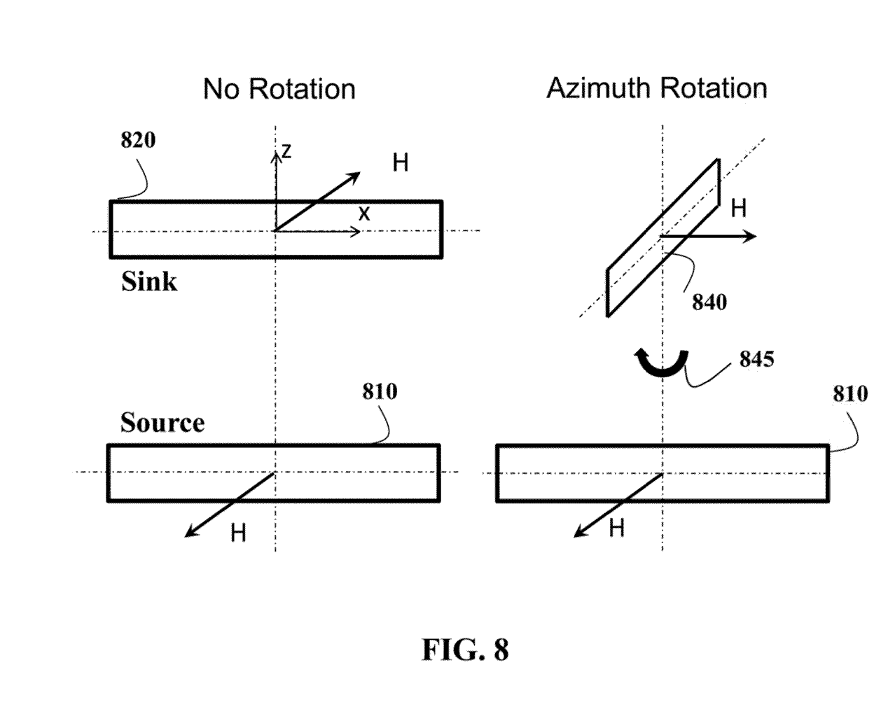

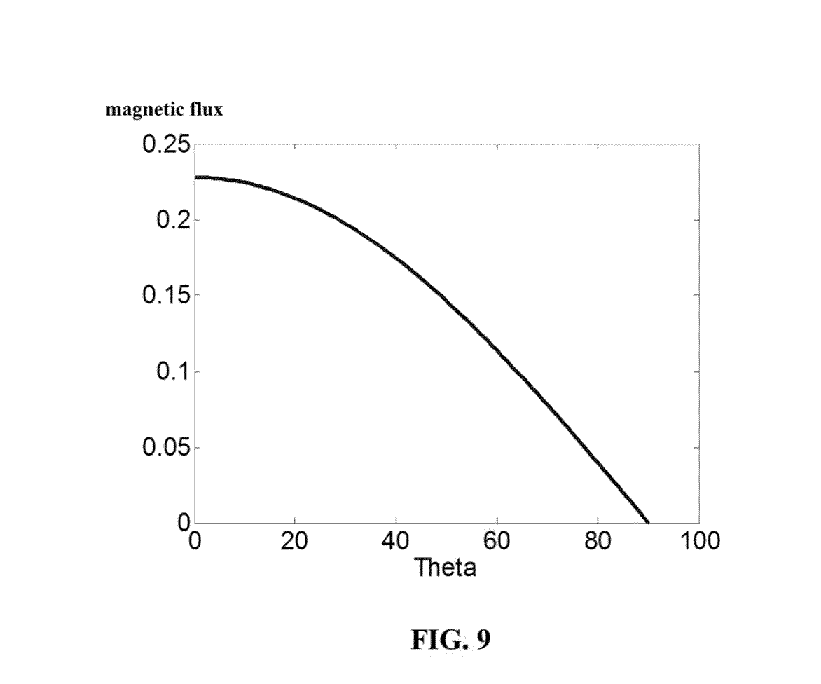

FIG. 8 shows a schematic of a system for improving the energy transfer with azimuth rotation of the resonator. Two rectangular coils 810 and 820 are aligned side-by-side. For example, during the coupling between the source and the sink, the coils of the source and the sink are arranged such that an axis of the coil of the source and an axis of the coil of the sink are in one plane, and the coil of the sink has a degree of freedom for azimuth rotation around the axis of the coil of the sink. However, this configuration does not tolerate azimuth rotation of a receiving coil 840. When the receiving coil follows the rotation along the z axis, the magnetic flux decreases to 0. The degradation follows cos² θ, as shown in FIG. 9.

Accordingly, some embodiments of the invention improve the degradation of the magnetic flux, i.e., the energy transfer, using circularly polarized magnetic field. In one embodiment, during the coupling between the source and the sink, an axis of a coil of the source is arranged on one line with an axis of a coil of the sink, and the coil of the sink is rotated 845 around the axis of the coil of the sink, such that a plane of the coil of the source differs from a plane of the coil of the sink.

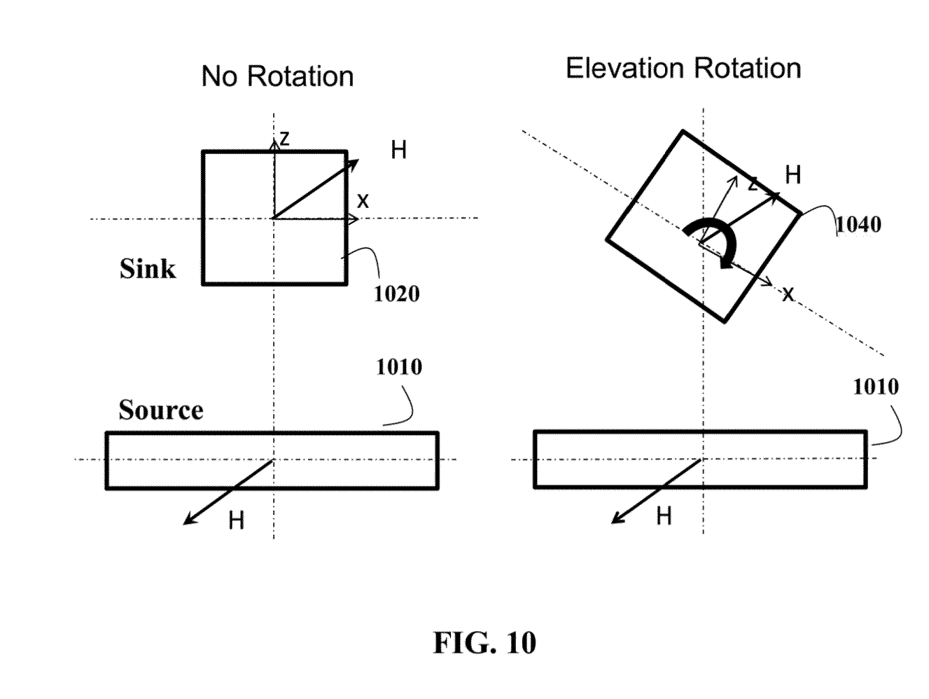

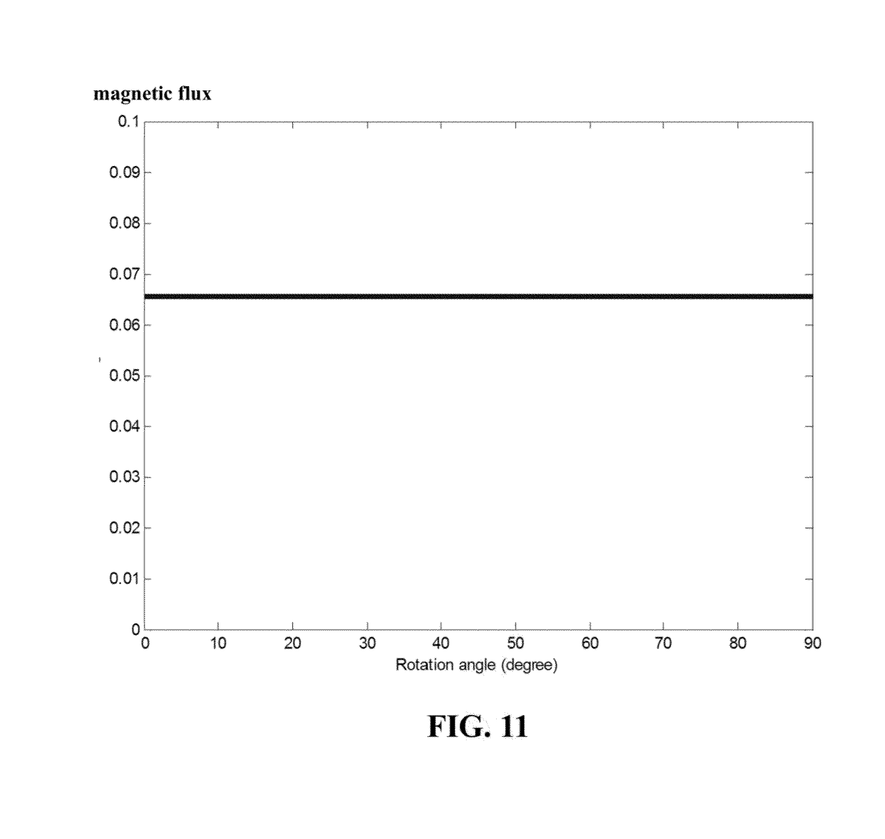

FIG. 10 is a schematic of wireless energy transfer system with square resonators placed side-by-side and with elevation rotation according to some embodiments of the invention. If the shape of the receiving coil is square 1020 or 1040, then the magnetic flux is almost constant, regardless of elevation rotation, as shown in FIG. 11. The shape of the transmitting coil 1010 can be rectangular. A wireless energy transfer system including a square receiving resonator is unaffected by elevation rotation.

Method for Generating Circularly Polarized Magnetic Field

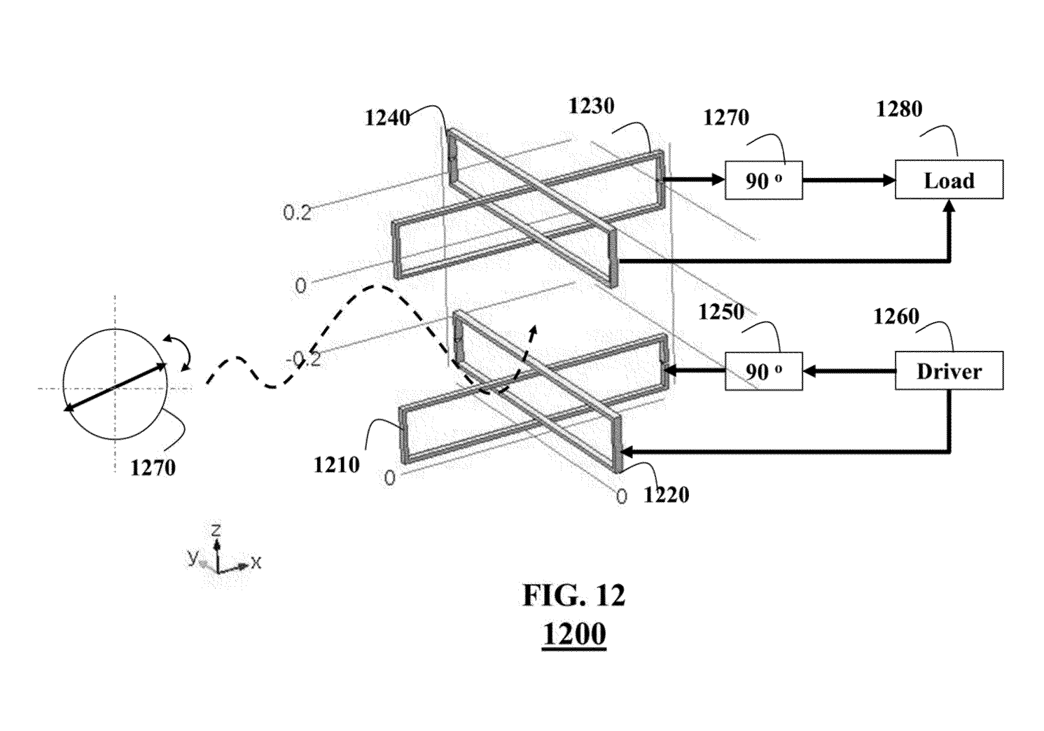

FIG. 12 shows a schematic of system 1200 for generating circularly polarized magnetic field according to some embodiments of the invention. The system 1200 includes a source having orthogonal coils 1210 and 1220. For example, the coils can be rectangular, circular or have other shapes. The system also includes a driver 1260 for supplying energy to the orthogonal coils 1210 and 1220 with feeding phase difference, e.g., 90° phase difference 1250. Upon receiving the energy, the source generates a circularly polarized field 1270, i.e., the magnetic field vector rotates over time.

Circularly polarized magnetic field can also be generated from an array of more than two elements of magnetic dipole antennas fed with particular phase difference depending on the number of elements in the array and the position of the elements. In another embodiment, a single coil with a single feed is wired such that the circularly polarized magnetic field is generated.

The system 1200 can also include a sink strongly coupled to the source for receiving the energy wirelessly via a resonant coupling of the field 1270. For example, the sink can include two orthogonal coils 1230 and 1240 with phase difference 90° 1270. The sink can supply energy to the load 1280. In alternative embodiment the sink includes only one coil. The net polarization of this system can either be RHCP or LHCP, depending on the phase relation, advance or lag.

Rotation impact on Orthogonal Wireless Power Transfer System

The impact of rotation on the above embodiment is now described. Elevation rotation of the orthogonal wireless power transfer system can be partitioned into two independent transfer system rotated around the y axis with θ_{y} and rotated around the x axis with θₓ. Here θ=θ_{y}=θₓ. The power transfer efficiency can be estimated by the magnetic flux crossing through the coils. Similarly, the azimuth rotation of the orthogonal wireless power transfer system can also be partitioned to two independent transfer systems, i.e., rotated around the z axis with φ and rotated around the x axis with φ. The phase difference of these two coils is 90 degrees. Therefore, both the transmit and receive systems are circularly polarized (either RHCP or LHCP).

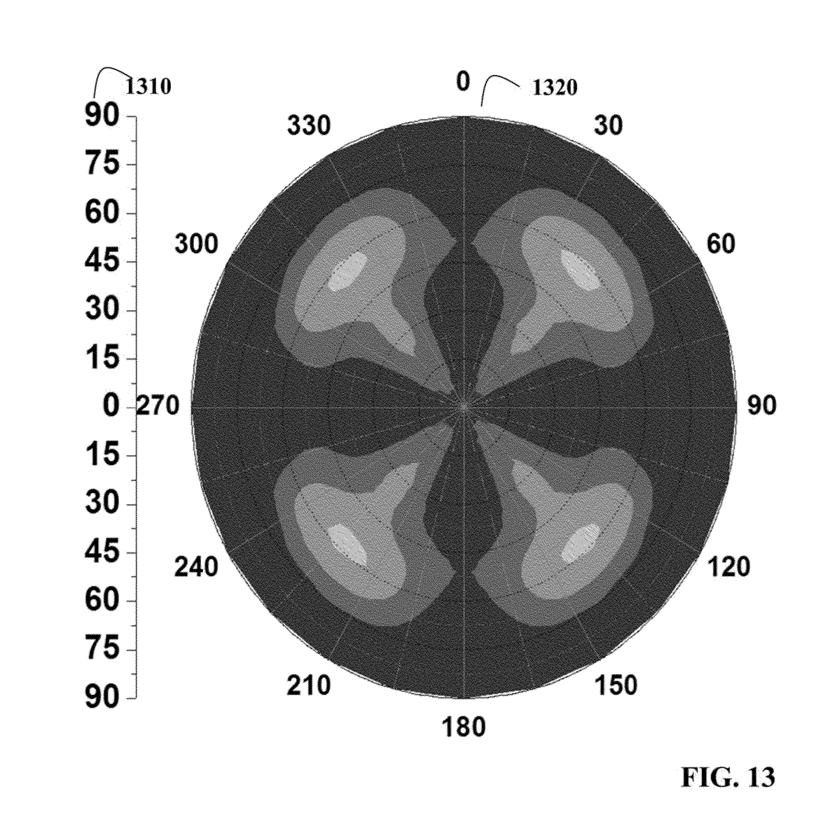

FIG. 13 shows a 2-D pattern of energy transfer efficiency on a grey scale in a polar coordinate system. The angular coordinate 1320 indicates the azimuth rotation angle φ. The radial coordinates 1310 indicate elevation rotation angle θ. The edge of the polar plot indicates θ=90, while the center indicates θ=0. The magnitude of power transfer efficiency was plot as a color contour with gradient shown in the legend. The maximums are observed at the edges and the center of the graph, which indicates a perfectly aligned orthogonal wireless power transfer system. The minimum 33% is observed at θ=45, φ=45, which is the worst case.

Considering two linearly polarized coils with 45 degrees of misalignment, the loss is approximately cos² 45°=0.5, corresponding to the energy transfer efficiency of less than 22%. Therefore, the circularly polarized orthogonal wireless power transfer system can reduce the degradation of coupling efficiency due to both azimuth rotation and elevation rotation.

Coupling Enhancement by Shielding

According to coupled-mode theory, the strength of the coupling is represented by a coupling coefficient k. The coupling enhancement is denoted by an increase of an absolute value of evanescent magnetic field. Some embodiments of the invention are based on a realization that the coupling efficiency can be enhanced by a shielding surface.

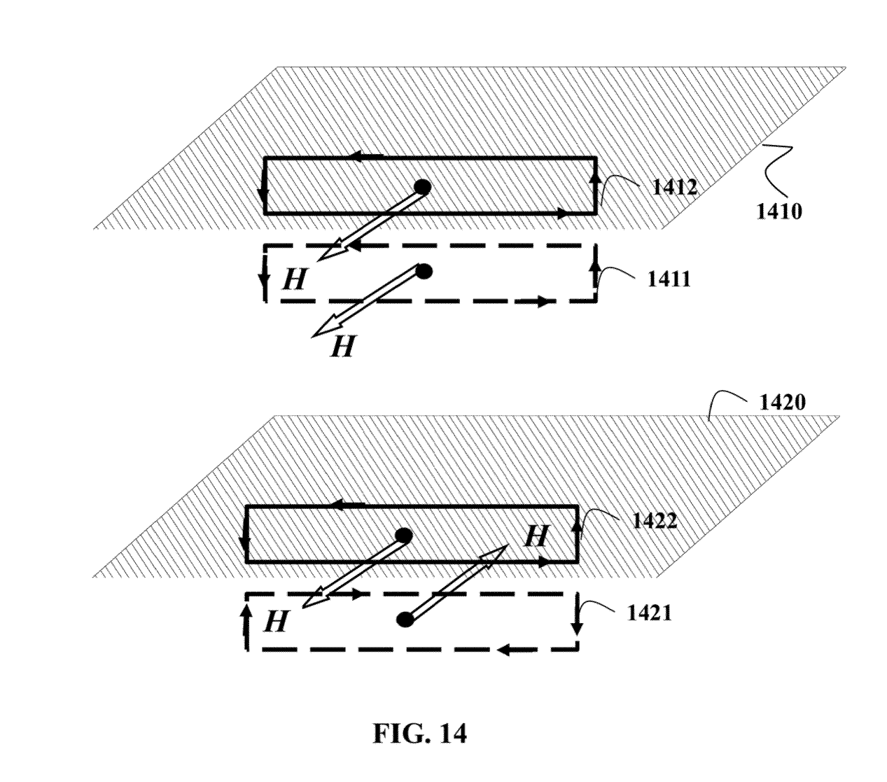

FIG. 14 shows an illustration of the shielding enhancement used by some embodiments of the invention. This shielding can be an electric conductor, such as a perfect electric conductor (PEC) plate 1410, or a magnetic conductor, such as a perfect magnetic conductor (PMC) plate 1420, or combination thereof.

An example of the PEC for the side-by-side resonator pair is a copper plate. According to the image theory, the image current due to the reflection from an electric conductor has an opposite current flowing direction. Considering a rectangular coil resonator 1412, arranged perpendicular to the copper plate shield, the image current loop 1411 has the some wiring as the original current. Therefore, the magnetic field is enhanced, which leads to enhancement: of the power transfer efficiency.

Although PMC does not exist in nature, there are artificially configured structures, which act as a magnetic conductor. According to the image theory, the image current due to the reflection from the magnetic conductor has a same current flowing direction. Considering a rectangular coil resonator 1422 arranged perpendicular to the magnetic conductor plate 1420, the image current loop has opposite wiring as the original current. Therefore, the magnetic field is reduced, which leads to degradation of the power transfer efficiency. However, if a plane of the coil is parallel to the PMC plate, than the usage of the PMC is advantageous.

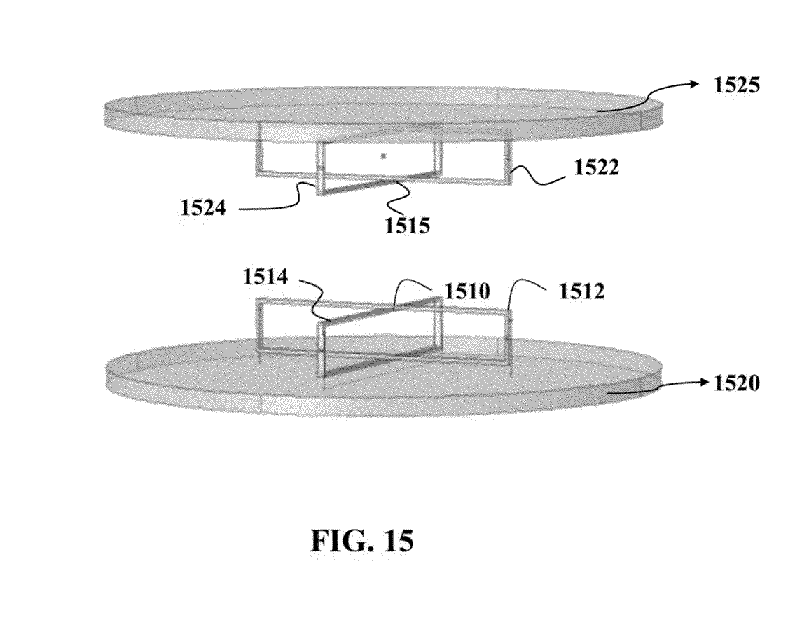

FIG. 15 shows the geometry of wireless power transfer system with PEC plates. The system includes the PEC plate 1520, e.g., a copper plate, arranged adjacent to a first resonator 1510. The resonator 1510 includes a pair of orthogonal coils, a coil 1512 and 1512.

The system also include a second resonator 1515 arranged at distal from the first resonator. The system can also optionally include a second PEC plate 1525 adjacent to the resonator 1515. The second resonator can include one or several coils. For example, the second resonator includes the coils 1522 and 1524 arranged side-by-side with corresponding coils 1512 and 1514. The plates 1520 and/or 1525 arranged within the field coupling the first and the second resonator a direction opposite to a direction of the energy transfer between the resonators, such that each plate prevents the field to propagate in a direction opposite to a direction of the energy transfer.

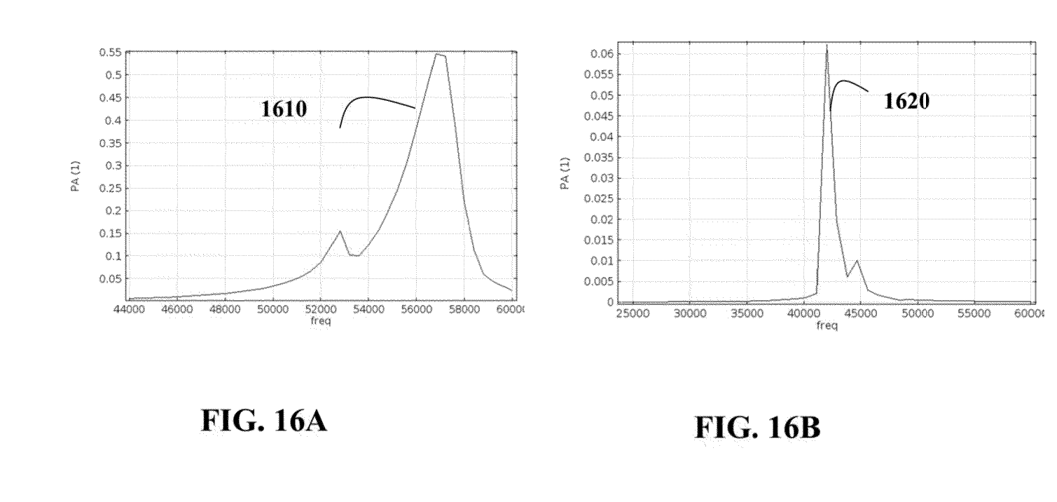

FIGS. 16A-B show the energy transfer efficiency for the system using PEC 1610 and PMC 1620, respectively. The unshielded system has 45% maximum efficiency, while 55% is observed for PEC shielding and <7% for PMC shielding. Therefore, the copper plates increase the power transfer efficiency by 10%.

Coupling between Asymmetric System

Some embodiments of the invention use an asymmetrical wireless energy transfer systems. In such system, the transmitting resonator is typically larger in size, more complicated in configurations and can have additional field refinement or focusing devices. For example, dimensions of a coil of the source can be greater than dimensions of a coil of the sink. The dimensions of the coil can include an area of the coil.

The transmitting :resonator generates a relatively large circular polarized magnetic field. The receiving resonator is smaller in size and with simpler structure when compared with the transmitting resonator. The receiving resonator can be embedded into a mobile object. Depending on the transmitting resonator, the receiving, resonator can have three degrees of freedom in motion while maintaining an efficient energy transfer.

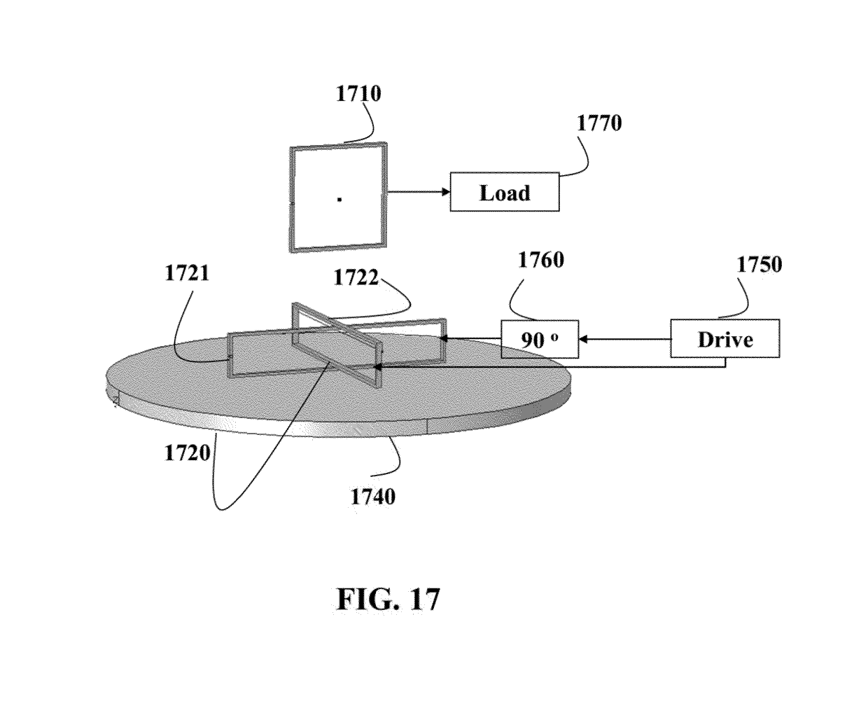

FIG. 17 shows an asymmetric wireless energy transfer system according to one embodiment. The system includes a receiving resonator with a single square coil 1710 and a transmitting resonator with a pair of orthogonal coils 172 1 and 1722. A copper plate 1740 is placed adjacent: the transmitting resonator for coupling enhancement. The transmitting resonators are fed by driver 1750. A 90 degree phase shifter 1760 is used to achieve circular polarized magnetic field. A load 1770 is connected to the receiving resonator.

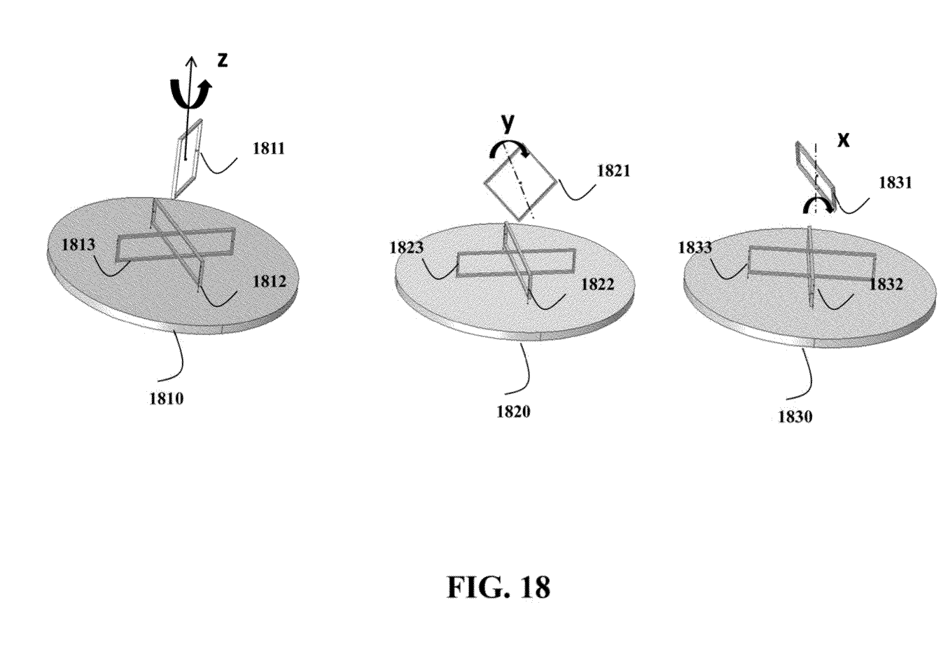

FIG. 18 shows examples of the rotations of the receiving resonator of FIG. 17 along the z 1810, y 1820 and x 1830 axis respectively. The rotation angles are φ, θ_{y}, and θₓ, respectively.

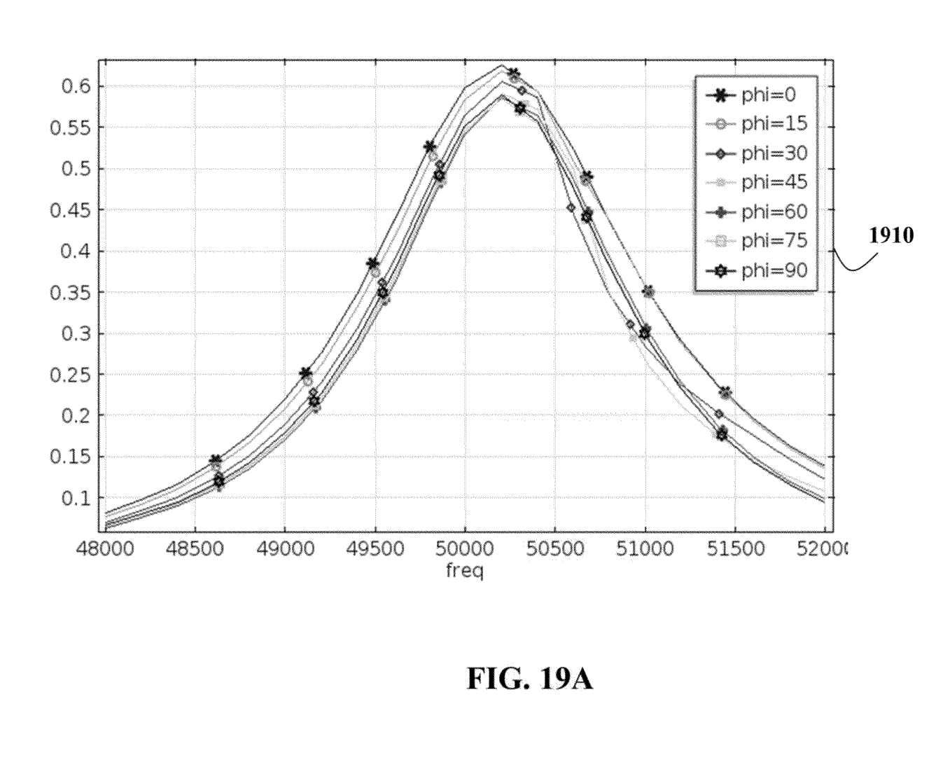

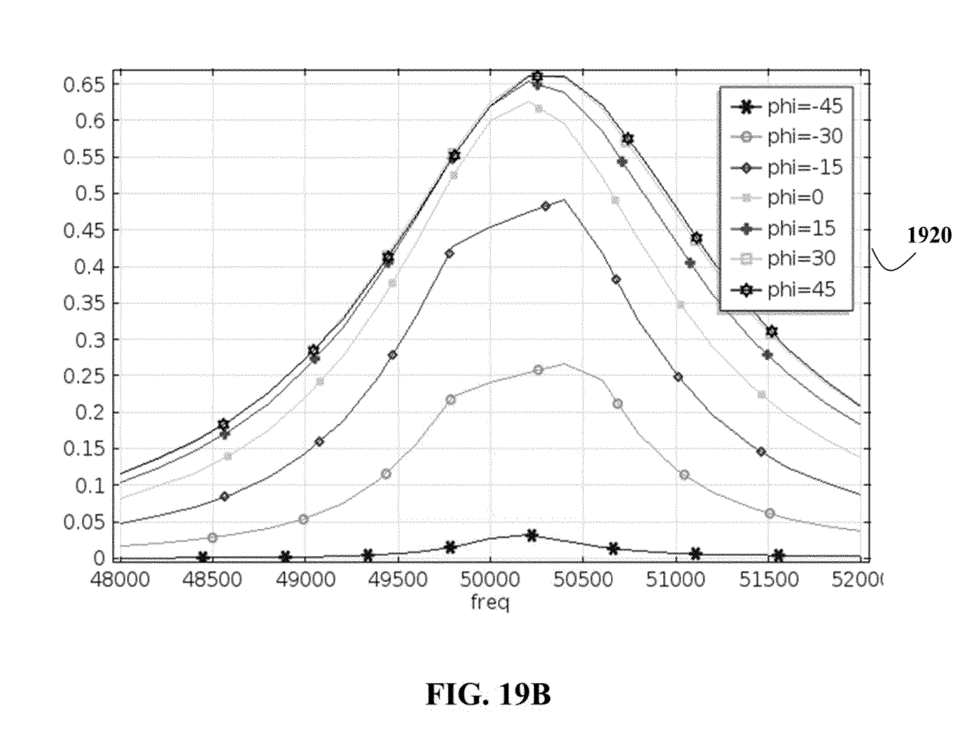

For the rotation 1810, the phase difference between resonator 1711 and 1712 is 0 or 90 degree, which generate linearly or circularly polarized magnetic field. The plot 1910 of FIG. 19A shows the energy transfer efficiency with 90 degree phase difference. The maximum efficiency is hardly decreased due to the circularly polarization. The plot 1920 of FIG. 19B shows the energy transfer efficiency with 0 degree phase difference. The maximum efficiency is significantly decreased due to the misalignment of linearly polarizations.

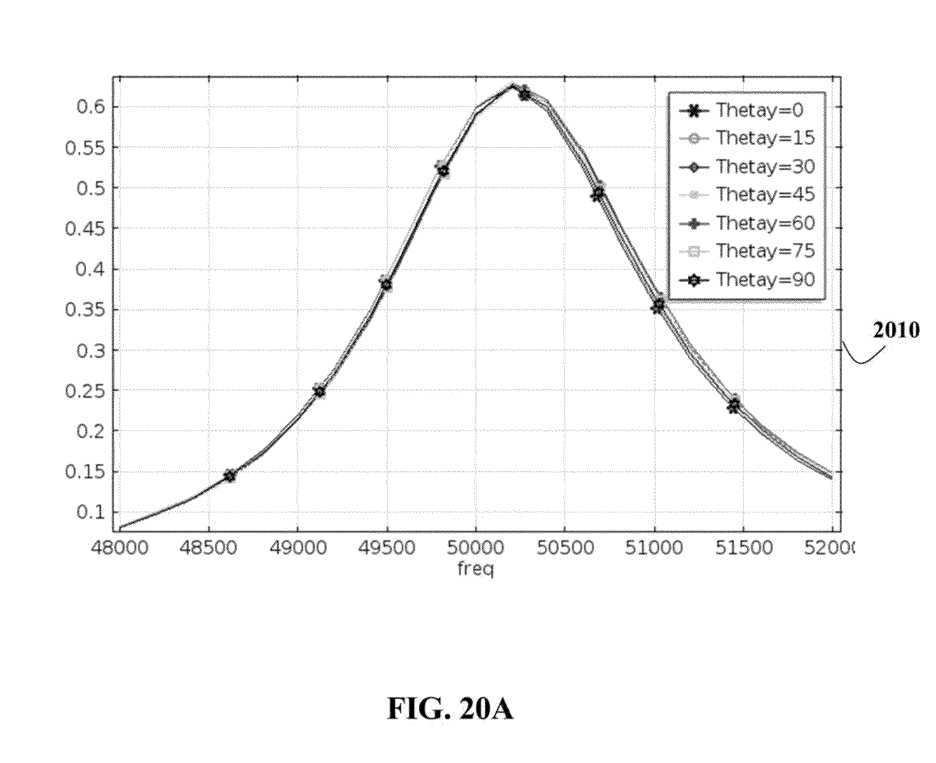

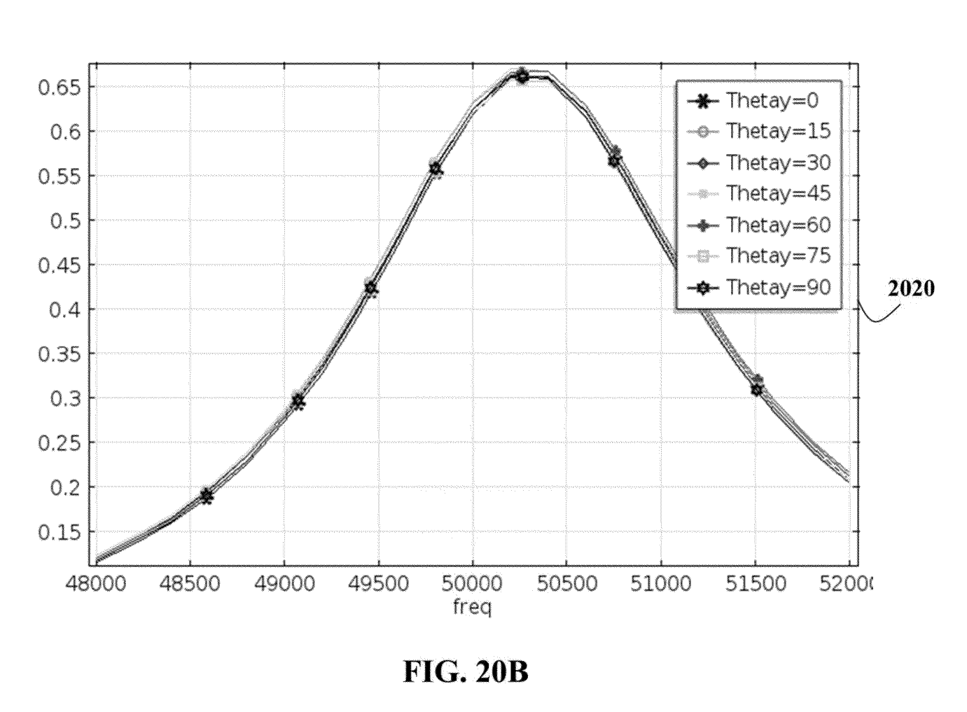

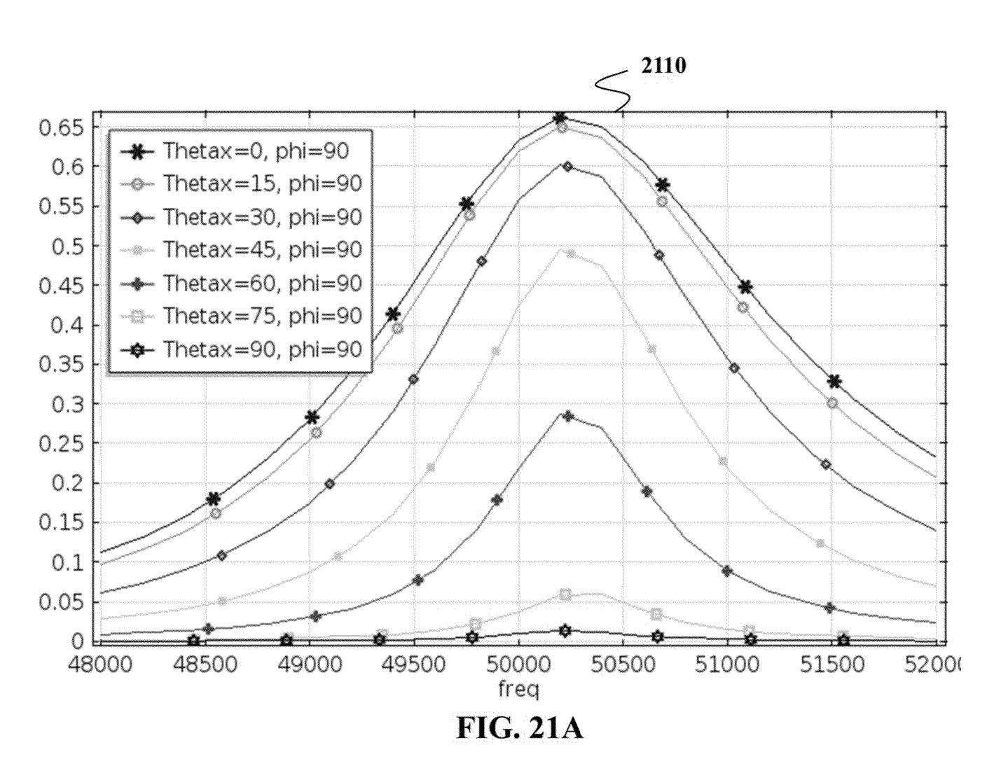

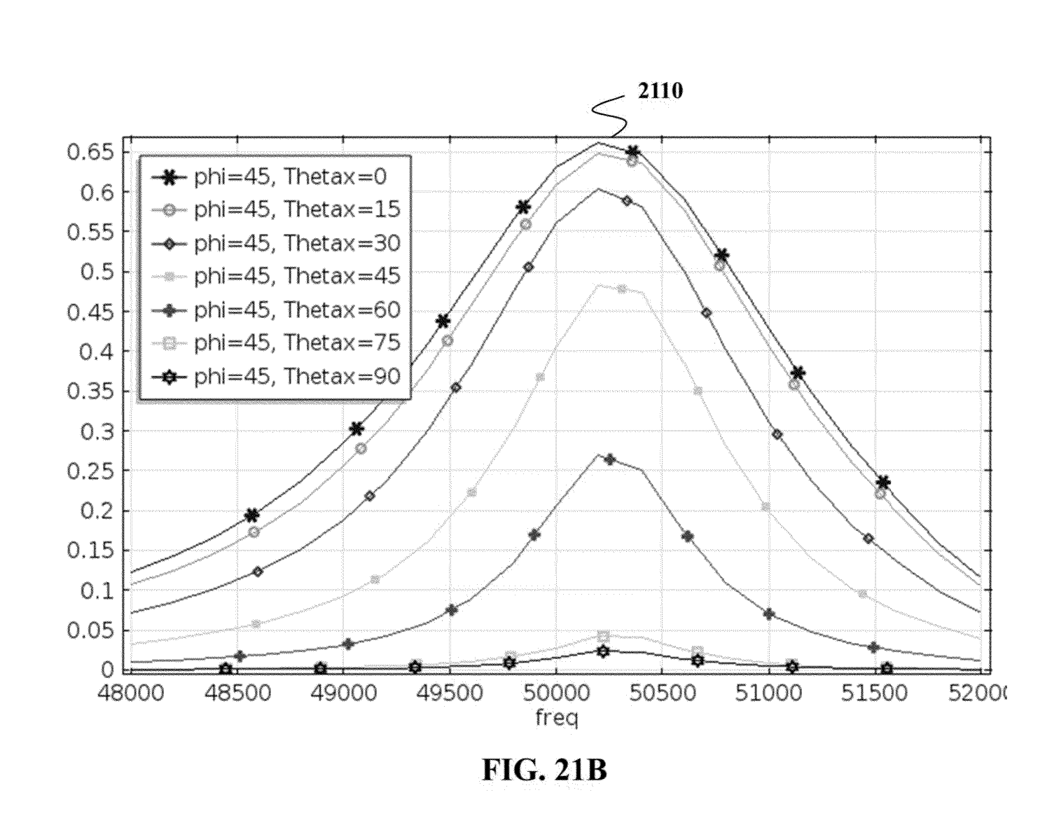

For the rotation 1820, the phase difference between resonator 1721 and 1722 is 0 or 90 degree, which generate linearly or circularly polarized magnetic field. The simulated results 2010 in FIG. 20A show the power transfer efficiency with 90 degree phase difference. The simulated results 2020 in FIG. 20B show the power transfer efficiency with 0 degree phase difference. The maximum efficiency of both cases are hardly decreased due to side-by-side arrangement of the resonators. The overall magnetic flux crossing the receiving resonator is constant regardless of rotation along y axis.

For the rotation 1830, the phase difference between resonator 1731 and 1732 is 0 or 90 degree, which generate linearly or circularly polarized magnetic field. The simulated result 2110 shows the power transfer efficiency with 90 degree phase difference. The simulated result 2120 shows the power transfer efficiency with 0 degree phase difference. The maximum efficiency of both cases is significantly decreased due to misalignment of the resonators. The overall magnetic flux crossing the receiving resonator is decreased significantly regardless of polarization of the transmit resonator pair.

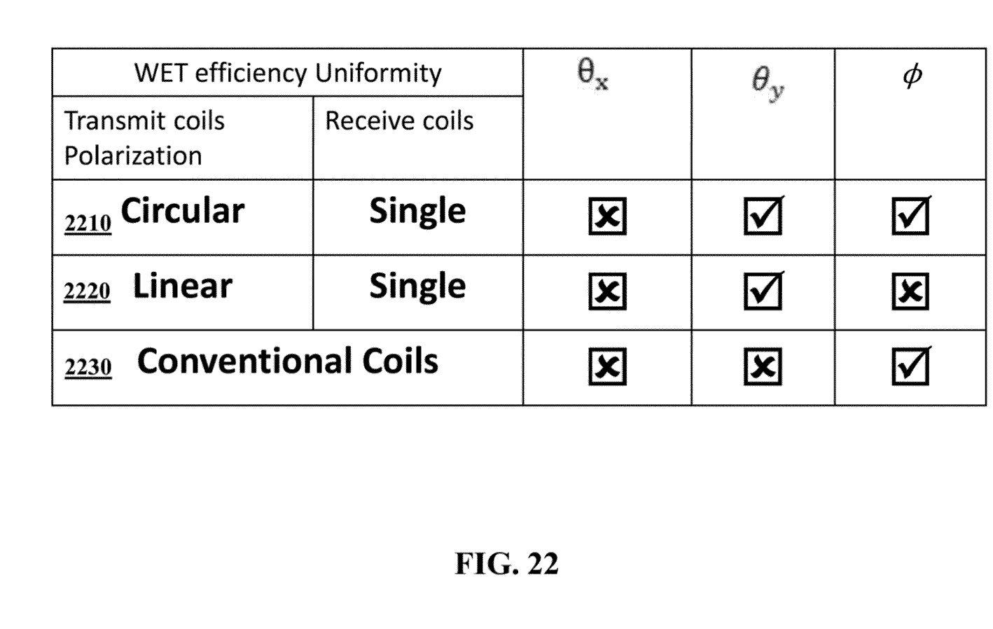

FIG. 22 summarizes the uniformity of wireless energy transfer efficiency under different rotation misalignment, e.g., with rotation angle φ, θ_{y}, and θₓ. A system with circularly polarized transmitting resonator module and single receiving module (2210), have uniform efficiency pattern regardless of rotation angle φ, θ_{y}, but not for θₓ. A system with linearly polarized transmitting resonator and single receiving resonator (2220), has uniform efficiency pattern regardless of rotation angle θ_{y}, but not for θₓ and φ. A system with linearly polarized transmitting resonator and conventional receiving resonator (2230) has uniform efficiency pattern regardless of rotation angle φ, but not for θₓ and θ_{y}.

Thus, it is advantageous to use the system with circularly polarized transmitting resonators. Circularly polarized magnetic field shows advantages over linearly polarized systems by adding an additional degree of rotation freedom. Possible applications of resonators generating circularly polarized magnetic field include wireless power transfer to mobile devices like cell phone, GPS, and PDA 3023. By using the circularly polarized magnetic field, these devices have one additional degree of rotation freedom.

The above-described embodiments of the present invention can be implemented in any of numerous ways. For example, the embodiments may be implemented using hardware, software or a combination thereof.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A system for transferring energy wirelessly, comprising:
a source for generating a circular polarized field in response to receiving the energy; and
a sink strongly coupled to the source for receiving the energy wirelessly via a resonant coupling of the field.

2. The system of claim 1, wherein the field is electromagnetic field and includes two perpendicular fields having 90° difference in phases, and substantially equal amplitudes.

3. The system of claim 1, wherein, during the coupling between the source and the sink, a coil of the source is arranged side-by-side with a coil of the sink, such that an axis of the coil of the source and an axis of the coil of the sink are in one plane, wherein the coil of the sink has a degree of freedom for azimuth rotation around the axis of the coil of the sink.

4. The system of claim 1, wherein, during the coupling between the source and the sink, an axis of a coil of the source is arranged on one line with an axis of a coil of the sink, and the coil of the sink is rotated around the axis of the coil of the sink, such that a plane of the coil of the source differs from a plane of the coil of the sink.

5. The system of claim 1, further comprising:
a load for receiving the energy from the sink; and
a driver for supplying the energy to the source such that the source generates the circular polarized field.

6. The system of claim 1, wherein the source includes a pair of orthogonal coils, and further comprising:
a driver for supplying the energy to coils in the pair with 90° difference in phases.

7. The system of claim 6, wherein the sink includes a pair of orthogonal coils arranged side-by-side with the pair of orthogonal coils of the source.

8. The system of claim 1, wherein the source includes a pair of orthogonal coils and a perfect electric conductor (PEC) plate arranged adjacent to the coils.

9. The system of claim 1, wherein the sink includes a pair of orthogonal coils and a perfect electric conductor (PEC) plate arranged adjacent the coils.

10. The system of claim 1, wherein dimensions of a coil of the source are greater than dimensions of a coil of the sink.

11. The system of the claim 1, wherein an area formed by a coil of the source is greater than an area formed by a coil of the sink.

12. A method for transferring energy wirelessly, comprising:
generating a circular polarized field in response to receiving the energy; and
transferring the energy wirelessly via a resonant coupling of the field.

13. The method of claim 12, further comprising:
increasing a coupling coefficient of the coupling using an electric conductor plate arranged within the field on a direction opposite to a direction of the energy transfer.

14. The method of claim 12, further comprising:
increasing a coupling coefficient of the coupling using an electric conductor plate arranged within the field such that the plate prevents the field to propagate in a direction opposite to a direction of the energy transfer.

15. The method of claim 12, further comprising:
receiving the energy as two signals having 90° difference in phases.
